(19) United States
(12) Patent Application Publication
(10) Pub. No.: US 2020/0244747 A1
(43) Pub. Date: Jul. 30, 2020

(54) INFORMATION PROCESSING DEVICE, INFORMATION PROCESSING METHOD, AND COMPUTER PROGRAM

(71) Applicant: SONY CORPORATION, TOKYO (JP)

(72) Inventors: MASAKAZU UKITA, KANAGAWA (JP); MITSURU TAKEHARA, TOKYO (JP)

(21) Appl. No.: 16/635,601

(22) PCT Filed: May 10, 2018
(86) PCT No.: PCT/JP2018/018131

§ 371 Date: Jan. 31, 2020

(30) Foreign Application Priority Data
Aug. 10, 2017 (JP) 2017-156202

(51) Int. Cl. H04L 29/08; G06Q 50/26

(52) U.S. Cl. CPC H04L 67/18; G06Q 50/26; H04L 67/12

(57) ABSTRACT

[Problem] To provide an information processing device, an information processing method, and a computer program capable of processing information in a certain region and transmitting the abstracted data to a higher-level device to construct a hierarchical distributed database on distributed computers.

[Solution] The information processing device includes a control unit configured to perform control to: abstract information collected from a region in a certain range in accordance with setting information; and transmit the abstracted information from a communication unit to a higher-level device.

### FIELD

The present disclosure relates to an information processing device, an information processing method, and a computer program.

### BACKGROUND

In recent years, environment sensing is performed by various devices and a massive volume of data concerning events and phenomena is collected. Techniques as described below have been proposed as methods of processing and accumulating such a massive amount of data.

For example, Patent Literature 1 below discloses a system in which a large amount of data associated with a spatial entity is organized in layers of data having a mutual relation.

Patent Literature 2 below discloses a system that detects risks emerging in various systems and that, in order to associate a detected risk with its relative impact on a system or a product, a server connected to a communication network receives and stores risk information from geographically distributed computerized data sources through a communication network.

Patent Literature 3 below discloses a system in which geographical elements are hierarchized and linked with data to improve the efficiency in searching.

Patent Literature 4 below discloses a support system that receives a task information request to request task information including a plurality of hierarchized tasks (hierarchized tasks) from a terminal device, determines a word (request-related word) about the task information request, and determines task information based on the request-related word.

### CITATION LIST

### Patent Literature

Patent Literature 1: JP 2002-530766 A

Patent Literature 2: JP 2007-520019 A

Patent Literature 3: JP 5174279 B2

Patent Literature 4: JP 2005-251029 A

### SUMMARY

### Technical Problem

According to the literatures above, data is constructed in a hierarchy, or risk information is received from geographically distributed computerized data sources. Unfortunately, processing and accumulating a massive amount of data at a central server in one place involves high communication cost and requires a wide communication band, high computation capability, and enormous storage space.

The present disclosure then provides an information processing device, an information processing method, and a computer program capable of processing information in a certain region and transmitting abstracted data to a higher-level device to construct a hierarchical distributed database on distributed computers.

### Solution to Problem

According to the present disclosure, an information processing device is provided that includes a control unit configured to perform control to: abstract information collected from a region in a certain range in accordance with setting information; and transmit the abstracted information from a communication unit to a higher-level device.

According to the present disclosure, an information processing method is provided that includes: performing control by a processor to: abstract information collected from a region in a certain range in accordance with setting information; and transmit the abstracted information from a communication unit to a higher-level device.

According to the present disclosure, a computer program is provided that causes a computer to function as a control unit performing control to: abstract information collected from a region in a certain range in accordance with setting information; and transmit the abstracted information from a communication unit to a higher-level device.

### Advantageous Effects of Invention

According to the present disclosure, information in a certain region is processed and abstracted data is transmitted to a higher-level device, whereby a hierarchical distributed database on distributed computers can be constructed.

The effect above is not necessarily limitative, and any effects illustrated in the present description or other effects that may be construed from the present description may be achieved in addition to the effect above or instead of the effect above.

### BRIEF DESCRIPTION OF DRAWINGS

FIG. 1 is a diagram for explaining an overview of an information processing system according to an embodiment of the present disclosure.

FIG. 2 is a block diagram illustrating an example of the configuration of a sensor terminal according to the present embodiment.

FIG. 3 is a block diagram illustrating an example of the configuration of a server according to the present embodiment.

FIG. 4 is a sequence diagram illustrating a basic operation process in implementation according to the present embodiment.

FIG. 5 is a sequence diagram illustrating a basic operation process in implementation according to the present embodiment.

FIG. 6 is a sequence diagram illustrating an operation process for changing setting information according to the present embodiment.

FIG. 7A is a sequence diagram illustrating an operation process of database construction of information about Cherry Blossom Front according to the present embodiment.

FIG. 7B is a sequence diagram illustrating an operation process of database construction of information about Cherry Blossom Front according to the present embodiment.

FIG. 8 is a diagram illustrating a screen display example for general users in database construction of information about Cherry Blossom Front according to the present embodiment.

FIG. 9 is a diagram illustrating a screen example appearing when the “Send image” button illustrated in FIG. 8 is selected.

FIG. 10 is a diagram illustrating a screen example appearing when the Send button illustrated in FIG. 9 is selected.

FIG. 11 is a sequence diagram illustrating an operation process of database construction of information about an influenza epidemic according to the present embodiment.

FIG. 12A is a sequence diagram illustrating an operation process of a database construction example for chain store customer analysis according to the present embodiment.

FIG. 12B is a sequence diagram illustrating an operation process of database construction example for chain store customer analysis according to the present embodiment.

FIG. 13 is a sequence diagram illustrating an operation process of database construction for traffic information according to the present embodiment.

FIG. 14 is a sequence diagram illustrating an operation process of database construction for traffic information according to the present embodiment.

FIG. 15 is a diagram illustrating an example of the hardware configuration of an information processing device according to the embodiment.

### DESCRIPTION OF EMBODIMENTS

Preferred embodiments of the present disclosure will be described in detail below with reference to the accompanying drawings. In the present description and drawings, the components having substantially the same functional configuration are denoted by the same reference signs and an overlapping description is omitted.

The description will be given in the following order.

1. Overview of information processing system according to an embodiment of the present disclosure

2. Configuration
2-1. Configuration of sensor terminal 1
2-2. Configuration of server 2

3. Examples
3-1. Basic operation process
3-2. Operation process in setting change
3-3. Database construction example for Cherry Blossom Front
3-4. Database construction example for influenza epidemic
3-5. Database construction example for chain store customer analysis
3-6. Database construction example for traffic information

4. Closing

### 1. OVERVIEW OF INFORMATION PROCESSING SYSTEM ACCORDING TO AN EMBODIMENT OF THE PRESENT DISCLOSURE

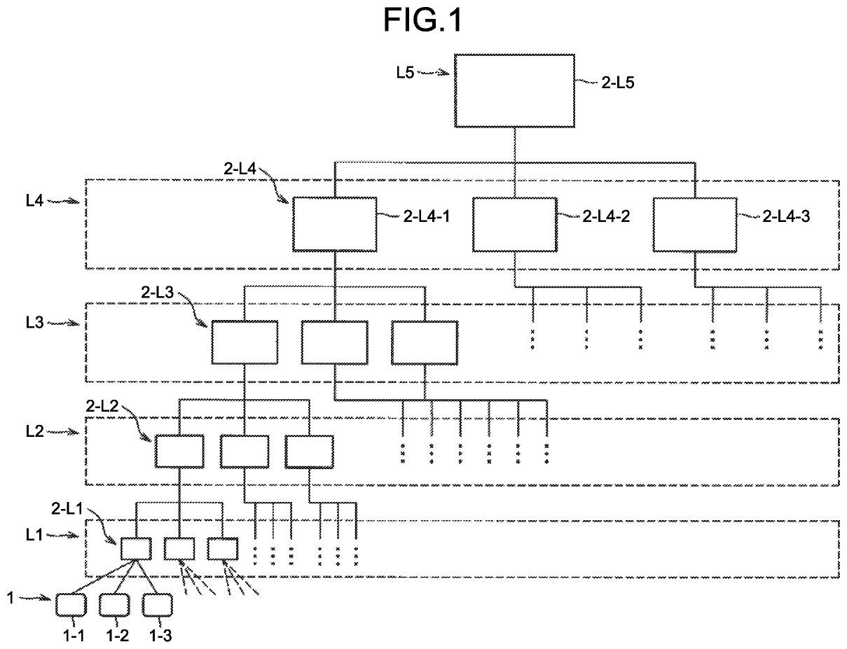

FIG. 1 is a diagram for explaining an overview of an information processing system according to an embodiment of the present disclosure. As illustrated in FIG. 1, the present system enables construction of a hierarchical distributed database on distributed computers.

Layers L1 to L5 illustrated in FIG. 1 include one or more servers 2. Each server 2 processes and accumulates information collected from regions in a certain range and transmits information abstracted in accordance with predetermined setting information to a server on a higher layer. Here, it is assumed that a server on a higher level of layers requires more summarized (abstracted) information (for example, only average values and variances in a certain period, or a recognition result obtained by image recognition of image data (for example, a recognized event, only the name of an object, etc.), rather than raw data).

Layers L1 to L5 are, for example, geographical layers and may collect, process, and accumulate data on a neighborhood association level, a municipal level, a prefectural level, a district level, and a national level, respectively.

For example, the first layer L1 is a data layer on the neighborhood association level, and each of servers 2-L1 included in Layer L1 collects, processes, and accumulates a variety of sensor data in neighborhood associations from sensor terminals 1. The server 2-L1 transmits information obtained by abstracting the sensor data in accordance with predetermined setting information to each of servers 2-L2 on the second layer L2 which are servers on the higher layer.

Next, the second layer L2 is a data layer on the municipal level, and each of servers 2-L2 included in Layer L2 collects, processes, and accumulates data on the municipal level from the servers 2-L1 on Layer L1 on the neighborhood association level. The server 2-L2 abstracts the collected data on the municipal level in accordance with predetermined setting information and transmits the abstracted data as data on the neighborhood association level to each of servers 2-L3 on the third layer L3 which are servers on the higher layer.

Such processing is repeated similarly, so that data on the prefectural level can be processed on the third layer L3, data on the district level can be processed on the fourth layer L4, and data on the national level can be processed on the fifth layer L5.

In this way, in the present system, a hierarchical distributed database can be constructed with severs distributed based on geographical layers. With this configuration, necessary and sufficient information for each region can be held by a group of servers with minimum communication cost, communication band, processing capability, and storage space. In the present description, a subordinate server directly connected to a certain server (parent server) in the hierarchical structure is referred to as child server.

The information processing system according to an embodiment of the present disclosure has been described above. A specific configuration of each device included in the information processing system according to the present embodiment will now be described with reference to the drawings.

### 2. CONFIGURATION

<2-1. Configuration of Sensor Terminal 1>

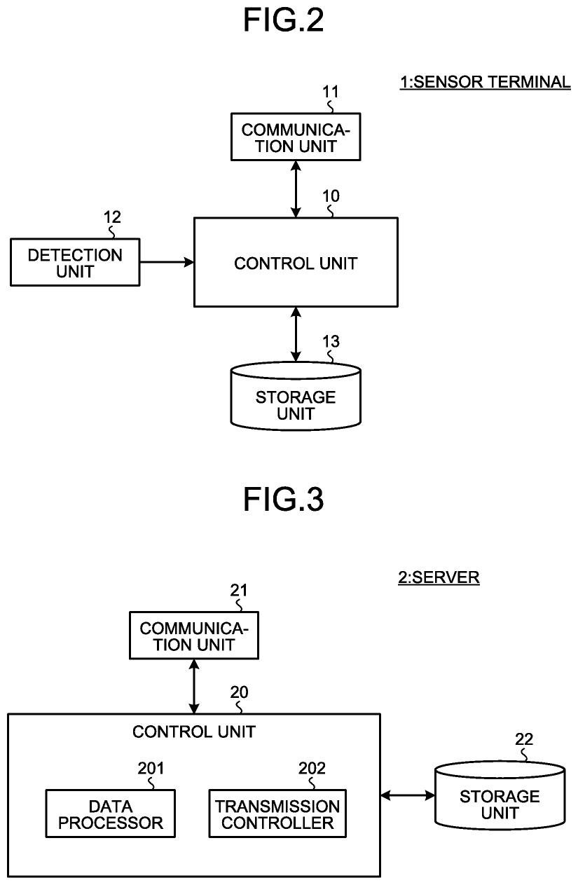

FIG. 2 is a block diagram illustrating an example of the configuration of the sensor terminal 1 according to the present embodiment. As illustrated in FIG. 2, the sensor terminal 1 includes a control unit 10, a communication unit 11, a detection unit 12, and a storage unit 13.

The control unit 10 functions as an arithmetic processing unit and a control device and controls the entire operation in the sensor terminal 1 under instructions of a variety of computer programs. The control unit 10 is implemented by, for example, an electronic circuit such as a central processing unit (CPU) and a microprocessor. The control unit 10 may include a read only memory (ROM) storing computer programs and arithmetic operation parameters to be used and a random access memory (RAM) temporarily storing parameters changing as appropriate.

The control unit 10 according to the present embodiment performs control such that a variety of data detected by the detection unit 12 is transmitted to a server 2 (specifically, a server 2x on the bottom layer) through the communication unit 11.

(Communication Unit 11)

The communication unit 11 connects to an external device by wire or by radio to transmit/receive data to/from the external device. The communication unit 11 may establish communication connection with a server 2 through a network, for example, via a wired/wireless local area network (LAN), or Wi-Fi (registered trademark), Bluetooth (registered trademark), near field communication, or a mobile communication network (long term evolution (LTE), the third generation of wireless mobile telecommunication network (3G)).

(Detection Unit 12)

The detection unit 12 is a sensor device that acquires surrounding information. For example, the detection unit 12 is implemented by, for example, a camera sensor, a microphone, a position measuring unit, a motion sensor, a biometric sensor, or an environment sensor.

(Storage Unit 13)

The storage unit 13 is implemented by a read only memory (ROM) storing computer programs and arithmetic operation parameters to be used in the processing by the control unit 10 and a random access memory (RAM) temporarily storing parameters changing as appropriate. The storage unit 13 may accumulate information acquired by the detection unit 12.

The configuration of the sensor terminal 1 according to the present embodiment has been specifically described above. The sensor terminal 1 may be installed, for example, in a town, a park, nature, facilities, or a building to continuously or periodically monitor the surrounding state. When the sensor terminal 1 is installed in a location with no constant power supply, the sensor terminal 1 includes a battery to be charged by some methods (solar power generation, wind generation, energy harvesting, for example) or periodically replaced.

<2-2. Configuration of Server 2>

FIG. 3 is a block diagram illustrating an example of the configuration of the server 2 according to the present embodiment. As illustrated in FIG. 3, the server 2 includes a control unit 20, a communication unit 21, and a storage unit 22.

(Control Unit 20)

The control unit 20 functions as an arithmetic processing unit and a control device and controls the entire operation in the server 2 under instructions of a variety of computer programs. The control unit 20 is implemented by, for example, an electronic circuit such as a central processing unit (CPU) and a microprocessor. The control unit 20 may include a read only memory (ROM) storing computer programs and arithmetic operation parameters to be used and a random access memory (RAM) temporarily storing parameters changing as appropriate.

The control unit 20 according to the present embodiment also functions as a data processor 201 and a transmission controller 202.

The data processor 201 performs a process of abstracting data collected from a lower layer in accordance with setting information. The setting information includes the settings of the degree of abstraction and the frequency of abstraction, and data is abstracted in accordance with setting information different for each layer. For example, the setting information may be transmitted from a higher-level server and may define the degree of abstraction such as the kind or content of information, importance, and degree of detail required by the higher-level server. Such setting information is also transmitted to the sensor terminal 1 similarly. For example, a server on the bottom layer may transmit setting information in which the kind or content of information and the frequency of transmission required by the server itself are set, to a sensor terminal 1 in a certain region.

The setting information may be transmitted from a lower-level server and may define the degree of abstraction such as the kind or content of information and the frequency of updating required by the lower-level server.

The setting information may be input by an administrator and may define the degree of abstraction required by a higher-level server or the server 2 itself. The highest-level server does not have a higher-level server but may have setting information in which the degree of summarizing or abstraction and the frequency of summarizing, abstraction, or updating (importance) are set for each kind and content of information.

The data processor 201 may calculate the degree of importance of abstracted information. For example, the degree of importance of information may be calculated based on preset usability or urgency, in accordance with the content of information. More specifically, for example, information about earthquakes, tsunami, eruptions, large-scale fires may have a high urgency, whereas road traffic information may have a lower urgency. The degree of importance of information may be calculated, for example, based the number of times the information is referred to by users and the number of users. This is because information referred to more frequently and referred to by more users is thought to be more useful. In this case, the degree of importance may be multiplied by a weight different for each server or for each user and summed up. Such a degree of importance is transmitted to a higher-level device (or a lower-level device) together with the abstracted information. Information with a high degree of importance may be transmitted to a higher-level server at a frequency higher than the set frequency of updating.

The transmission controller 202 transmits data abstracted by the data processor 201 to a server 2 on the higher layer.

(Communication Unit 21)

The communication unit 21 connects to an external device by wire or by radio to transmit/receive data. The communication unit 21 establishes communication connection with another server on a higher layer or another server on a lower layer or, in the case of a server on the bottom layer, a sensor terminal 1, for example, via a wired/wireless local area network (LAN) or Wireless Fidelity (Wi-Fi, registered trademark).

(Storage Unit 22)

The storage unit 22 is implemented by a ROM storing computer programs and arithmetic operation parameters to be used in the processing by the control unit 20 and a RAM temporarily storing parameters changing as appropriate. For example, the storage unit 22 according to the present embodiment may store data acquired from a lower layer through the communication unit 21 and data obtained by abstracting the acquired data. Setting information about data abstraction is stored in the storage unit 22.

The configuration of the server 2 according to the present embodiment has been specifically described above.

### 3. EXAMPLES

Examples of the information processing system according to the present embodiment will now be specifically described with reference to the drawings.

<3-1. Basic Operation Process>

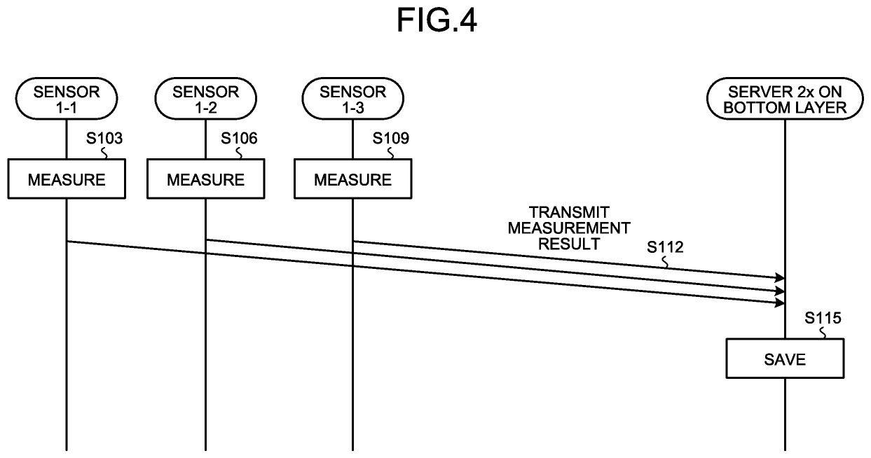

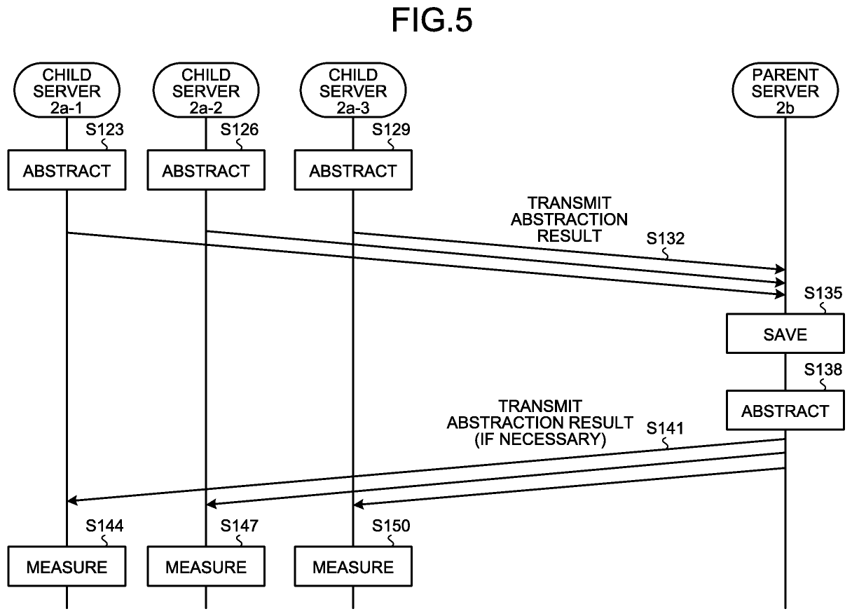

Referring now to FIG. 4, a basic operation process in implementation is described. FIG. 4 to FIG. 5 are sequence diagrams illustrating a basic operation process in implementation according to the present embodiment.

As illustrated in FIG. 4, first of all, each sensor terminal 1 performs sensing of a surrounding state (a variety of measurement) (steps S103 to S109) and transmits the measurement result to a server 2x on the bottom layer (step S112). Each sensor terminal 1 extracts information relevant to the content requested by the server 2x on the bottom layer that is a higher-level device in accordance with the setting information and then transmits the information summarized and abstracted in accordance with the requested degree of detail.

Subsequently, the server 2x on the bottom layer saves the measurement result transmitted from each sensor terminal 1 (step S115).

The basic operation of each sensor terminal 1 and each server 2x on the bottom layer have been described above. Referring now to FIG. 5, the basic operation between a lower-level server and a higher-level server is described.

As illustrated in FIG. 5, a child server 2a extracts information relevant to the content requested by a parent server 2b that is a higher-level device in accordance with its owned setting information (setting information set for the information required by the higher-level server), summarizes and abstracts the information in accordance with the requested degree of detail (step S123 to S129), and transmits the abstraction result to the parent server 2b (step S132). In this case, the child server 2a may calculate and add the degree of importance of the information based on the preset usability and/or urgency.

Subsequently, the parent server 2b saves the information transmitted from each child server 2a (step S135).

Subsequently, when there exists a child server 2a that requires abstracted data of information on the lower layer, the parent server 2b performs abstraction (or any other processing) of the information in accordance with setting information (setting information set for the information required by the lower-level server) (step S138) and transmits the abstracted data to the child server 2a (step S141). When the degree of importance of information is high, the parent server 2b may transmit the information at a frequency higher than the set normal frequency of updating. The level of abstraction may be different for each child server 2a.

<3-2. Operation Process in Setting Change>

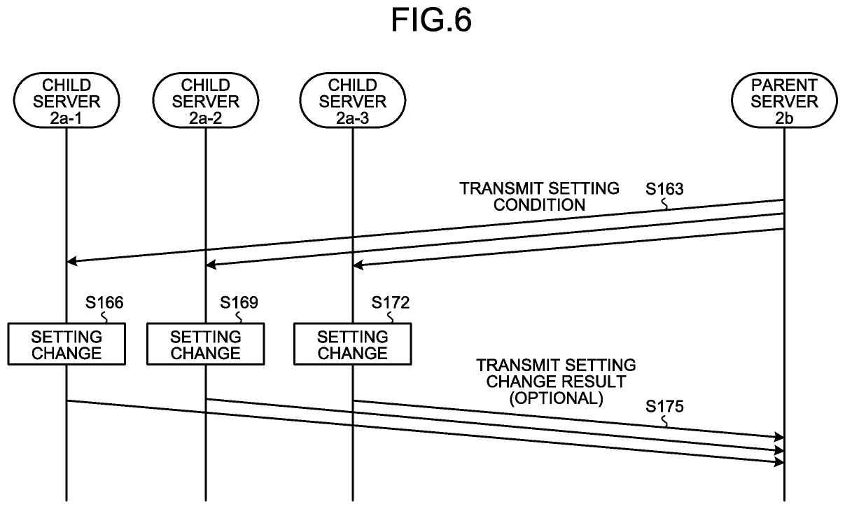

FIG. 6 is a sequence diagram illustrating an operation process for changing setting information. When the settings of a child server 2a under the control of a parent server 2b are to be changed according to an instruction by an administrator or an operator of the parent server 2b (for example, when the degree of detail or the frequency of transmission of information is increased in order to cope with any unexpected emergency event, or conversely, they are to be decreased in order to return to normal operation), the parent server 2b is allowed to perform setting change control for all the child servers 2a under its control, because it takes time and effort to change the settings of each individual child server 2a.

As illustrated in FIG. 6, first of all, the parent server 2b transmits the setting condition to be changed (the content of data provided by the child server 2a, the abstraction level, the transmission interval of notice) (step S163).

Subsequently, each of the child server 2a-1 to the child server 2a-3 makes a setting change, such as overwriting the setting information with the received setting condition (steps S166 to S172) and returns the setting change result to the parent server 2b (step S175). Returning the setting change result may be omitted.

The basic operation process and the operation process in setting change have been described above. Construction of a hierarchical distributed data base according to the present embodiment will now be described with more specific examples.

<3-3. Database Construction Example for Cherry Blossom Front>

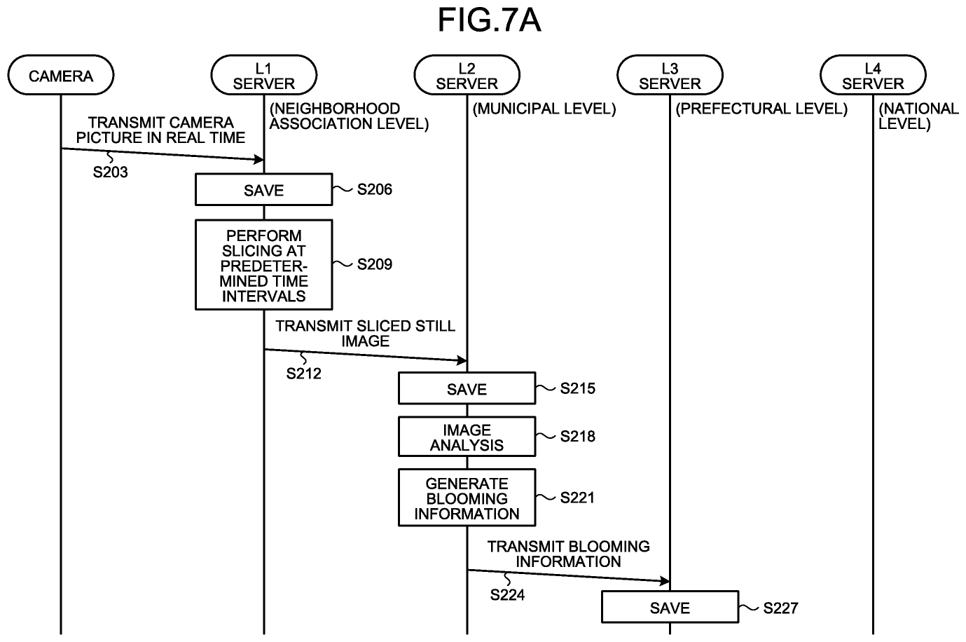

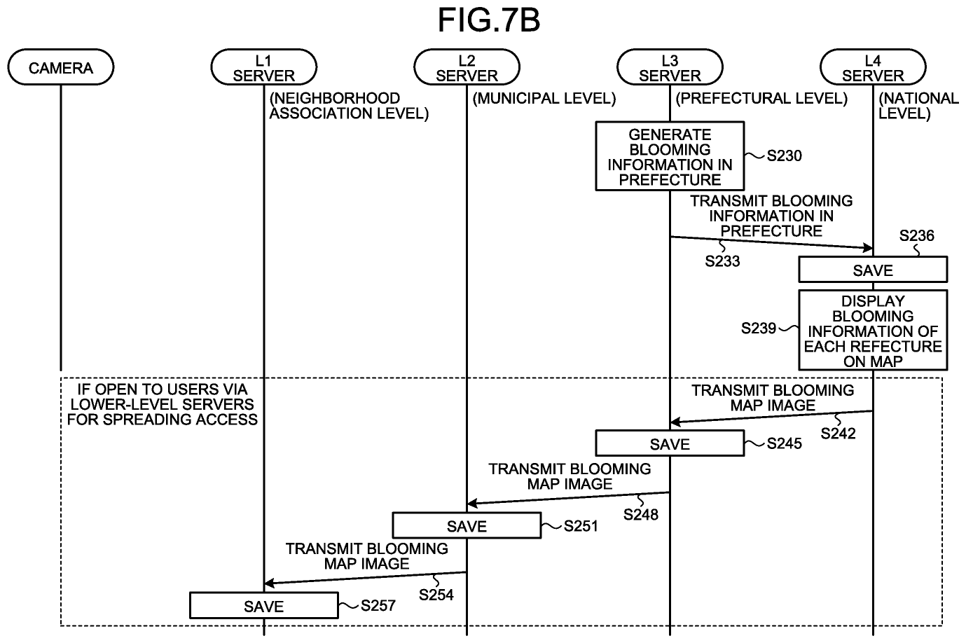

FIG. 7A and FIG. 7B are sequence diagrams illustrating an operation process of database construction of information about Cherry Blossom Front. Here, a camera is used as an example of the sensor terminal 1. In the present example, images of cherry trees may be captured by one or more Internet of Things (IoT) cameras installed in the cherry blossom spots in each region, and blooming information in each region may be generated based on the collected captured images. In the present example, as servers 2, L1 server that is a server on the first layer collects blooming information on the neighborhood association level, L2 server that is a server on the second layer collects blooming information on the municipal level, L3 server that is a server on the third layer collects blooming information on the prefectural level, and L4 server that is a server on the fourth layer collects blooming information on the national level.

As illustrated in FIG. 7A, first of all, each camera transmits a camera picture to L1 server in real time (step S203).

Subsequently, L1 server saves the received camera picture (step S206), slices the picture at predetermined time intervals (an example of abstraction in accordance with setting information) (step S209), and transmits the sliced still image to L2 server that is a higher-level server (step S212). L1 server may determine the duration of a picture to be saved in accordance with its storage capacity. L2 server (city/ward level) does not require real-time pictures of cherry blossoms and, for example, when only still images of every six hours are necessary, it is premised that L2 server transmits setting information in which transmission of still images of every six hours is set to L1 server that is a child server (neighborhood association level). Such transmission of setting information is performed once at the time of setting the entire system. When a new child server (L1 server) is added, the setting information may be transmitted to the child server each time. L1 server that is a child server slices the camera picture and obtains a still image in accordance with the setting information at every six hours, for example, and periodically transmits the sliced still image to L2 server that is a parent server (city/ward level).

Subsequently, L2 server saves the still image received from L1 server that is a child server (step S215).

Subsequently, L2 server performs image analysis of the still image received from each L1 server on the neighborhood association level (step S218), generates information of “blooming state” in the city/town/village, such as whether cherry trees come into bloom or the percentage of bloom (step S221), and transmits the generated information of blooming state (blooming information) to L3 server (step S221). In the present example, when still images are not necessary and only “blooming state” is necessary in L3 server that is a server on the next higher layer (prefectural level), it is premised that L3 server transmits setting information to give an instruction to generate and transmit a blooming state to L2 server that is a child server (city/ward level) in advance. L2 server that is a child server (city/ward level) then generates a “blooming state” in accordance with the setting information and periodically transmits the “blooming state” to L3 server that is a parent server (prefectural level).

Subsequently, L3 server saves the “blooming information” received from L2 server that is a child server (step S227).

Subsequently, L3 server generates blooming information in the prefecture, based on the “blooming information” on each municipal level (step S230), and transmits the generated blooming information to L4 server (step S233). In the present example, since blooming information in the entire prefecture is necessary in L4 server that is a server on the next higher layer (national level), L3 server calculates, for example, the average value of blooming state in the entire prefecture, based on the “blooming information” on each municipal level, in accordance with the setting information and generates “prefectural blooming state” (an example of abstraction of data).

Subsequently, L4 server saves information of the blooming state for each prefecture (step S236).

Subsequently, L4 server may process the blooming information for each prefecture, for example, by generating an image in which blooming information of each prefecture is presented on a map (for example, the prefectural blooming states are color-coded) (step S239). The national blooming information thus processed (blooming map image) may be provided to customers as necessary. In order to avoid intense access to L4 server that is the highest-level server (national level), as illustrated in FIG. 7B, a blooming map image may be transmitted to and saved in servers on the lower layers in order.

For example, first of all, L4 server transmits a blooming map image to L3 server (step S242), and L3 server saves the received blooming map image (step 5245) and also transmits the received blooming map image to L2 server on the lower layer (step S248).

Subsequently, L2 server saves the received blooming map image (step S251) and also transmits the received blooming map image to L1 server on the lower layer (step S257).

With this processing, intense access to the highest-level server (national level) can be avoided.

When customers wish to know a blooming state in more detail, they can obtain it by accessing a server on the corresponding layer (L3 server for the prefectural level, L2 server for the city/ward level, and L1 server for the neighborhood association level).

The setting information on the information transmitted from a parent server to a child server may be transmitted from the child server to the parent server. Thus, for example, information of the blooming state in the neighborhood can be obtained from a higher-level server. It may also be set that a blooming state in the nearer region is transmitted more frequently. The content of information requested by each child server and the frequency of transmission as described above may be set in different ways according to regions.

(Screen Display Examples)

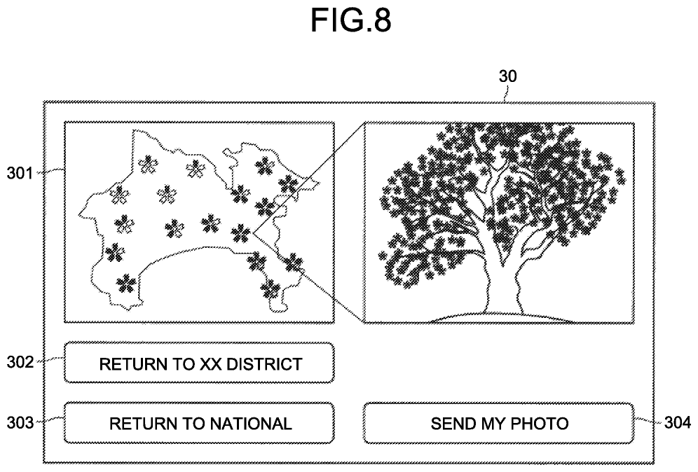

Referring to FIG. 8 to FIG. 10, screen display examples for general users in the present example will now be described.

FIG. 8 is a diagram illustrating a screen display example for general users in database construction of information about Cherry Blossom Front. A display screen 30 in FIG. 8 can be viewed, for example, on an information processing terminal owned by a user. For example, a blooming map image 301 on the prefectural level appears on the display screen 30 in FIG. 8. To view a map image on the district level, “Return to XX district” button 302 is selected. To view a map image on the national level, “Return to national” button 303 is selected. In this way, the range of the blooming map image can be switched. In the blooming map image 301, a cherry blossom mark on the map can be clicked to view a corresponding still image or a real-time image. General users can also participate in data construction. In this case, the user selects a “Send my photo” button 304.

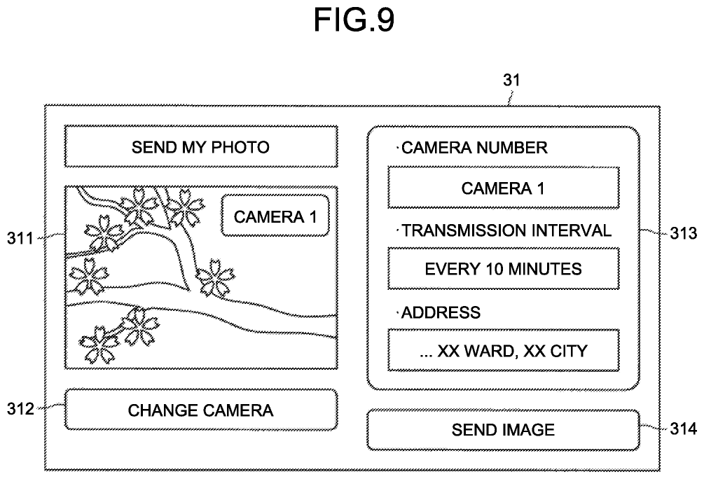

FIG. 9 is a screen example appearing when “Send my photo” button 304 in FIG. 8 is selected. As illustrated in FIG. 9, a camera image 311, a camera change button 312, a setting screen 313, and a send button 314 are displayed on a display screen 31. In the camera image 311, for example, a real-time picture taken by a camera with which the user's information processing terminal establishes communication connection or the captured still image is displayed. When there are a plurality of cameras, the camera change button 312 is selected and a popup image indicating a list of other cameras is displayed to allow the user to change cameras. In the setting screen 313, the camera number of the selected camera, the interval of transmission to a higher-level server, and the address of place of installation (the destination server may be determined by the address) are set (the default of camera number may be the camera number currently displayed).

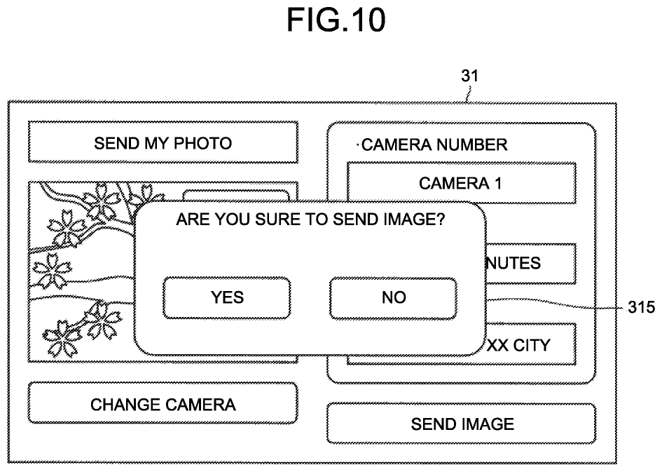

When the user selects the send button 314, as illustrated in FIG. 10, a popup image 315 is displayed to confirm transmission. Then, when the user clicks on “Yes”, the user's camera is registered in the destination server, and transmission of an image starts. In this way, general users also can send a picture of the camera set by themselves to a server on the bottom layer (server on the neighborhood association level) at any time through the Internet.

<3-4. Database Construction Example for Influenza Epidemic>

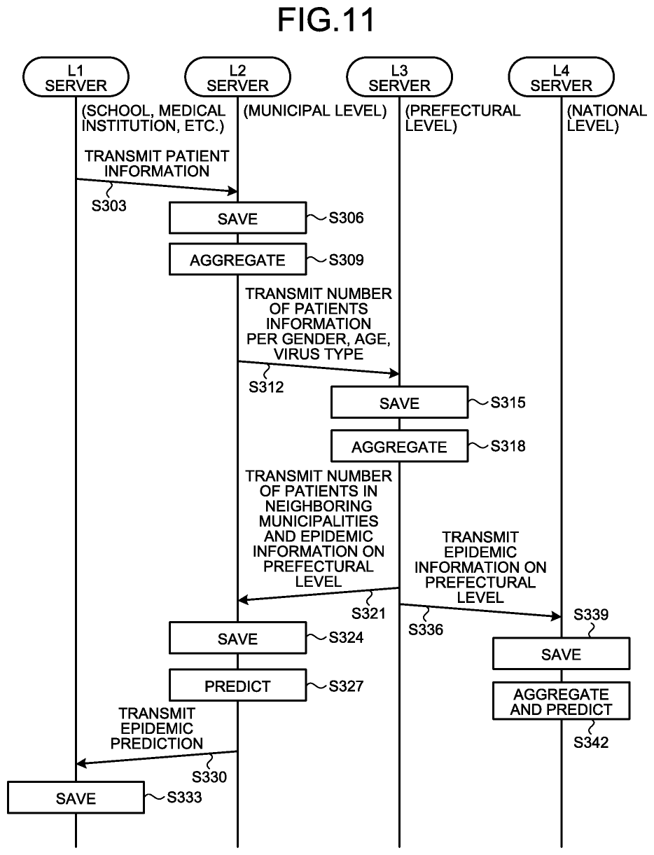

Referring to FIG. 11, a database construction example for an influenza epidemic will now be described. FIG. 11 is a sequence diagram illustrating an operation process of database construction of information about an influenza epidemic. In the present example, epidemic geographical spread can be predicted and a warning is issued, based on information of the number of influenza patients in school or regional medical institutions. It is assumed that the setting of the present system is performed by, for example, a public institution (for example, the Health, Labor and Welfare Ministry, healthcare center).

As servers 2, L1 server that is a server on the first layer collects patient information at school, medical institutions, and the like, L2 server that is a server on the second layer collects the number of patients information on the municipal level, L3 server that is a server on the third layer collects the number of patients and an epidemic on the prefectural level, and L4 server that is a server on the fourth layer collects influenza epidemic information on the national level.

As illustrated in FIG. 11, first of all, L1 server transmits patient information (gender, age, virus type, etc.) in school or regional medical institutions in a town, for example (almost in real time) to L2 server (step S303).

Subsequently, L2 server saves the received patient information (step 5306) and performs aggregation in accordance with the setting information (the setting such as information content required by L2 server that is the next higher-level server (prefectural level)) (step S309). For example, L2 server calculates the information on the number of patients by gender, age, or virus type.

Subsequently, L2 server transmits the aggregated number of patients information to L3 server (step S312).

Subsequently, L3 server saves the received number of patients information (step 5315) and performs aggregation in accordance with the setting information (the setting such as information content required by L4 server that is a next higher-level server (national level)) (step S318). For example, L2 server generates information about an influenza epidemic on the prefectural level.

Subsequently, L3 server may transmit the number of patients in the neighboring municipalities or epidemic information on the prefectural level to each L2 server, in accordance with the setting information in which information content required by L2 server that is a next lower-level server (municipal level) is set (step S321). The frequency of transmission of the number of patients in the neighboring municipalities or the epidemic information on the prefectural level to a lower-level server may be set higher than the epidemic information transmission frequency on the prefectural level to a higher-level server.

Subsequently, L2 server saves the received number of patients in the neighboring municipalities or the epidemic information on the prefectural level (step S324) and performs epidemic prediction in the region under its control (step S327). When patients have not yet been found in the region under control, but it is grasped that patients have been increasing in the neighboring municipalities, L2 server can predict that it is likely that patients will be found in the region under control. In the present embodiment, the status in the neighborhood is acquired from a higher-level server so that a warning can be given to people in the region under control. The “neighboring municipalities” are not necessarily adjacent municipalities.

L2 server then transmits epidemic prediction to L1 server (step S330), and the epidemic prediction is saved in L1 server (step S333).

L3 server transmits the epidemic information on the prefectural level to L4 server in accordance with the setting information (information set for the content of information or the transmission frequency requested by L4 server that is a higher-level server) (step S336).

Subsequently, L4 server saves the epidemic information on the prefectural level (step S339) and performs aggregation or prediction of epidemic of influenza on the national level, if necessary (step S342). The aggregation result and the prediction result serve as information useful for any political decision.

<3-5. Database Construction Example for Chain Store Customer Analysis>

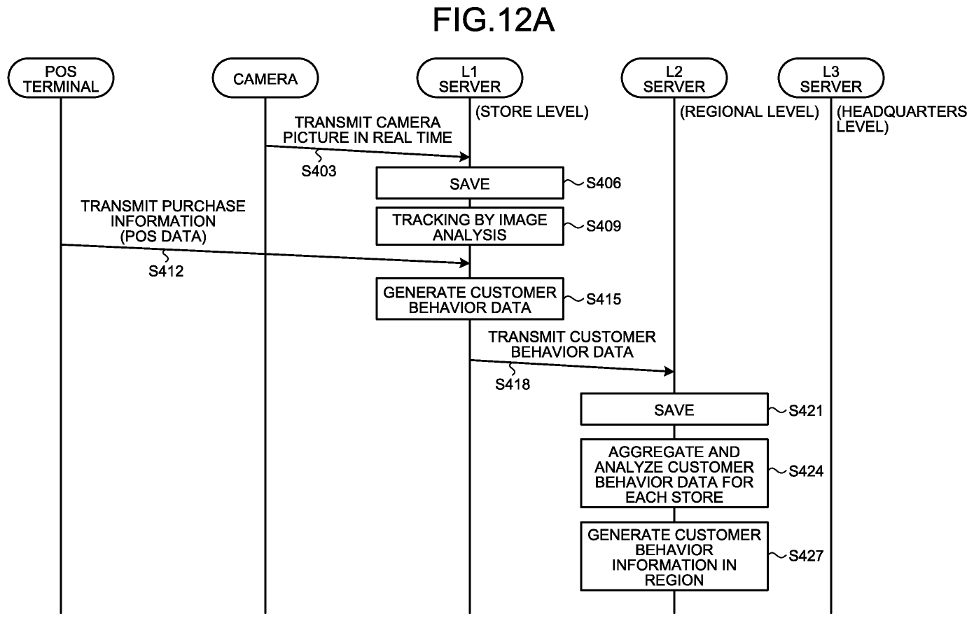

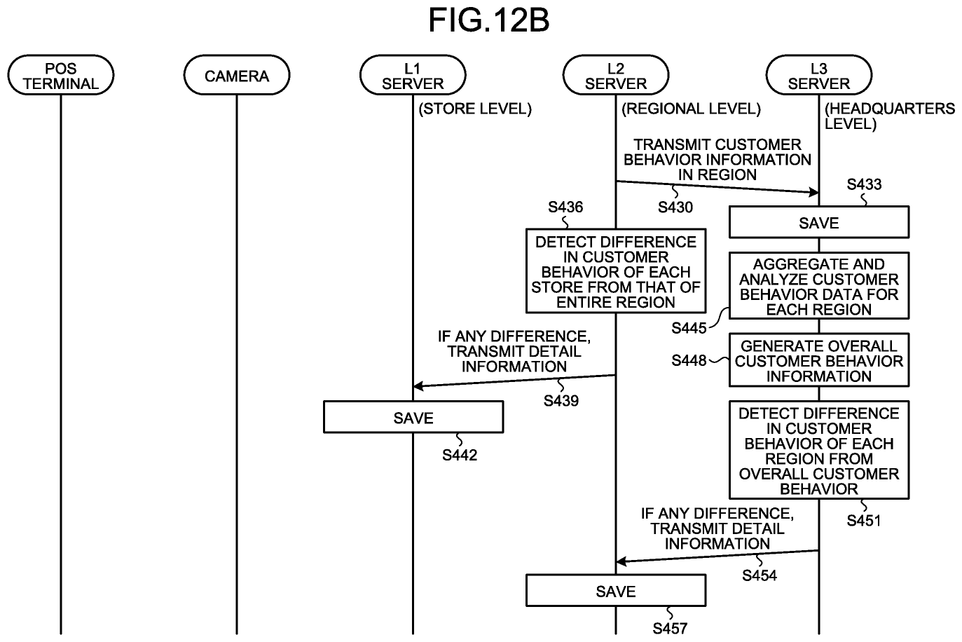

Referring to FIG. 12A and FIG. 12B, a database construction example for chain store customer analysis will now be described. FIG. 12A and FIG. 12B are sequence diagrams illustrating an operation process of a database construction example for chain store customer analysis.

Here, a POS terminal and a camera (IoT camera) are used as an example of the sensor terminal 1. As servers 2, L1 server that is a server on the first layer collects customer behavior information on the store level, L2 server that is a server on the second layer collects customer behavior information on the regional level, and L3 server that is a server on the third layer collects nationwide customer behavior information on the headquarters level.

As illustrated in FIG. 12A, first of all, each camera installed in a store transmits a camera picture in real time to L1 server (step S403).

Subsequently, L1 server saves the received camera picture (step S406), performs image analysis in accordance with the setting information, and performs behavioral tracking of customers in the store (step S409). In the present example, in addition to the purchase information (what kind of people bought what kind of items) of customers captured by the POS terminal, behavioral tracking information of customers in the store is collected, so that the customers' preference information can be grasped in more detail and can be used for optimization of placement and pricing of items.

Subsequently, the POS terminal installed in the store transmits the purchase information (POS data) to L1 server (step S412).

Subsequently, L1 server generates customers' behavior data based on the image analysis and the POS data (step S415). As specific examples of behavior data generation, for example, the customer's gender, age, and presence of an accompanying person (husband and wife, with kids, couple) may be grasped, and the customer's characteristic motion (for example, pick up an item on a shelf, look closely, or bend down to look) is compared with the item placement information registered in advance, whereby which item the customers are interested in can be grasped together with their motion. Information as to whether the customers actually bought the item that they are interested in (available combined with information of POS terminals) may also be acquired.

Subsequently, L1 server transmits the customer behavior data to L2 server (step S418). L1 server may transmit time, customer's profile, the item of interest with the motion at that time, whether the item was purchased, and the like, each time, to a regional server (L2 server) that supervises a plurality of stores. Transmitting such customer behavior data can reduce communication volume compared with when all pictures from a plurality of monitoring cameras are transmitted.

Subsequently, L2 server saves the customer behavior data received from each store (step S421), analyzes the data at predetermined time intervals (for example, every hour), and performs aggregation and analysis of customer behavior data as to “what kind of customers are interested in what kind of items at the time of day, and how much they purchased” for each store (step S424).

Subsequently, L2 server aggregates and analyzes customer behavior information of all the stores in the supervised region and generates customer behavior information in the entire region (step S427).

Subsequently, L2 server transmits the customer behavior information in the entire region to the headquarters server (L3 server) (step S430).

Subsequently, L3 server saves the customer behavior information in the entire region received from each region (step S433).

Subsequently, L2 server compares the customer behavior information for each store with the customer behavior information in the entire region (step S436), and if there is a difference, transmits detail information to L1 server to give a notice to a regional manager or the store manager or a person in charge in the store (step S439).

L1 server saves the received detail information (step S442). The difference information may provide a clue in planning for increasing the sales. Artificial intelligence (AI) may analyze such difference information together with other information (differences in store location or target buyers) and AI may generate a plan for increasing the sales.

Subsequently, L3 server aggregates and analyzes, for each region, the regional customer behavior information transmitted from L2 server (step S445) and generates customer behavior information in all regions (step S448).

Subsequently, L3 server compares, for each region, the regional customer behavior information with the customer behavior information in all regions and detects a difference (step S451).

Subsequently, if there is a difference, L3 server transmits detail information to L2 server (step S454) to give a notice to a regional manager. If there is a difference, L3 server may provide detail information to a person in charge at headquarters.

L2 server saves the received detail information (step S457). The regional manager or the person in charge at headquarters can use the detail information about the difference as a clue to planning for increasing the sales. Alternatively, AI may add other information (for example, the characteristics of each region, if foods, difference in ingredients and seasoning, and if clothing, preference for showy looks) for analysis, and AI may generate a plan for increasing the sales.

<3-6. Database Construction Example for Traffic Information>

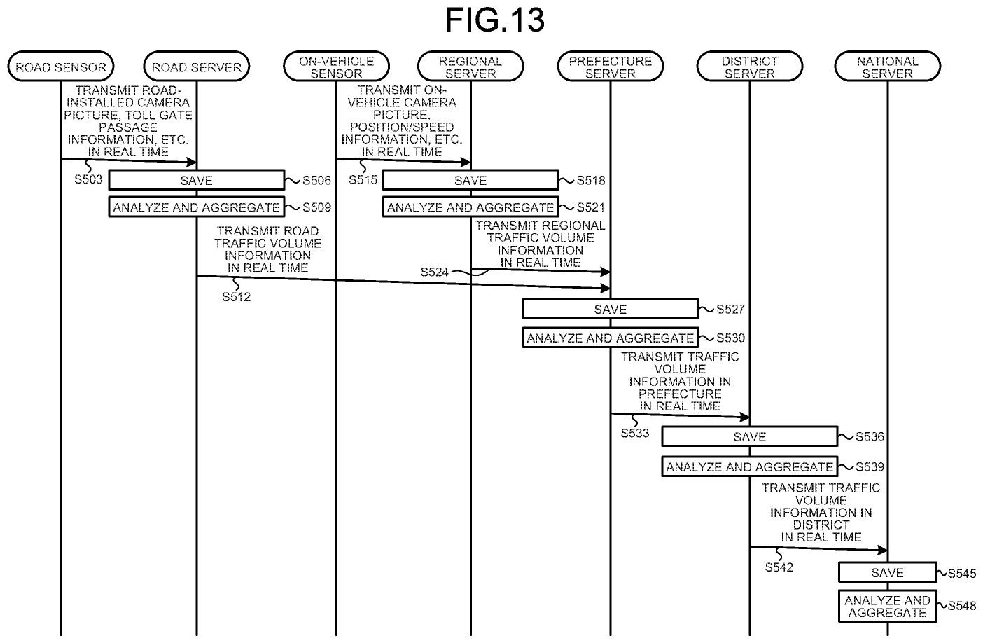

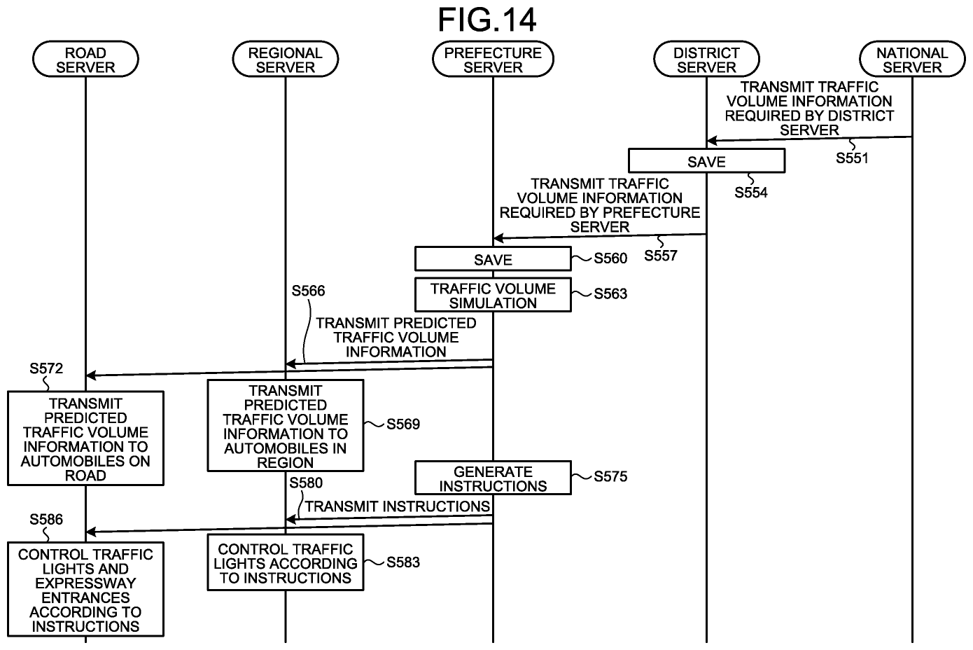

Referring to FIG. 13 to FIG. 14, a database construction example for traffic information will now be described.

In the present example, a road sensor (which detects passing cars and traffic condition and acquires camera pictures and toll gate passage records of expressways, etc.) and an on-vehicle sensor (which may be a drive recorder, for drive assistance, or for autonomous driving, and detects vehicle interior pictures, vehicle exterior pictures, position, speed information, and the like) are used as the sensor terminal 1.

A road server or a regional server may be assumed as the bottom layer server, a prefectural server may be assumed as the next higher layer, and a district server and a national server may be assumed as the next higher layers in order.

As illustrated in FIG. 13, first of all, a road sensor transmits a road-installed camera picture and toll gate passage information and the like to a road server in real time (step S503). The road server may be installed for each road (for each zone in the case of an expressway).

Subsequently, the road server saves sensor data acquired by the road sensor (step S506), analyzes and aggregates (abstracts) the sensor data in accordance with the setting information (step S509), and transmits road traffic volume information to a prefectural server in real time (step S512).

The on-vehicle sensor installed in each vehicle transmits an on-vehicle camera picture, position/speed information, and the like to a regional server in real time (step S515).

Subsequently, the regional server saves the sensor data acquired by the on-vehicle sensor (step S518), analyzes and aggregates (abstracts) the sensor data in accordance with the setting information (step S521), and transmits regional traffic volume information to a prefectural server in real time (step S514).

Subsequently, the prefectural server saves information received from a plurality of bottom-layer servers (step S527), analyzes and aggregates (abstracts) the information (step S530), and transmits traffic volume information in the prefecture to a parent server (district-level server) in real time (step S533).

Subsequently, the district server saves information received from a plurality of lower-level servers, similarly (step S536), analyzes and aggregates (abstracts) the information (step S539), and transmits district traffic volume information to the parent server in real time (national level server) (step S542).

The national server saves information received from a plurality of lower-layer servers (step S545) and analyzes and aggregates (abstracts) the information (step S548).

Subsequently, as illustrated in FIG. 14, the national server transmits to a district server traffic volume information required by the server in accordance with the setting information (step S551).

Subsequently, the district server saves the received traffic volume information (step 5554) and transmits to a prefectural server traffic volume information required by the server in accordance with the setting information (step S557).

Subsequently, the prefectural server saves the received traffic volume information (step S560) and simulates traffic volume with traffic volume information received from the district server in combination with information from the bottom-layer servers received at steps S512, S524 (step S563).

Subsequently, the prefectural server transmits traffic volume information predicted in each regional road to the bottom-layer servers, based on the simulation result of traffic volume (step S566).

The regional server that is a bottom-layer server transmits predicted traffic volume information to automobiles in the region (step S569). Each automobile then can search for the optimum route using the predicted traffic volume information.

The road server that is a bottom-layer server also transmits predicted traffic volume information to automobiles on the road (step S572).

Subsequently, the prefectural server generates and transmits instructions such as the illumination pattern of traffic lights and closure of entrance to an expressway, etc. to the bottom-layer servers, based on the simulation result of traffic volume, so as to make traffic as smooth as possible (for example, to prevent traffic jams) (steps S575, S580).

The regional server that is a bottom-layer server controls a traffic light in the region in accordance with the instructions (step S583).

The road server that is a bottom-layer server controls the traffic volume through control of the illumination pattern of traffic lights in the region or roads under its control and through closure of entrance to an expressway, etc. (step S586).

In such traffic volume simulation and generation of instructions in the server on the prefectural level, even more accurate prediction and more effective instruction generation are possible in combination with information of traffic accidents available from the police and information of falling objects and roadworks available from road administrators.

In addition, even more accurate prediction and more effective instruction generation are also possible using the traffic volume records in the past and considering, for example, dates, days of the week, time of day, weather, or event information available on the Internet.

Although the sequence diagrams explained above are described according to the flow of information, in actuality, transmission/reception and analysis of information may be constantly carried out. For example, the regional server constantly receives information from sensor terminals, constantly analyzes and summarizes the information, and transmits traffic volume information to a prefectural server. Simultaneously, the regional server constantly receives predicted traffic volume information from a prefectural server and transmits the received information to automobiles or controls traffic lights.

The traffic volume information transmitted from a higher-level server to a lower-level server may include information of geographically adjoining regions, prefectures, and districts, and information of geographically separated regions, prefectures, and districts connected through expressways. For example, it is assumed that the traffic volume in City A is significantly affected by the traffic volume of the adjoining municipalities in Prefecture B and is somewhat dependent on the traffic volume of a metropolitan expressway in Prefecture C at a far distance that leads to a certain road. The granularity (level of detail) of information required may also vary. For example, while information of metropolitan expressways could be rough, information of local traffic volume should be in more detail in some cases.

(Hardware Configuration Diagram)

An embodiment of the present disclosure has been described above. The processing in the server 2 described above is implemented by software in cooperation with hardware of an information processing device 100 described below.

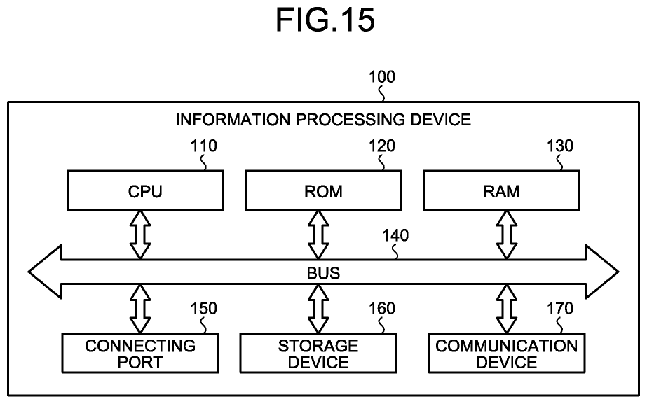

FIG. 15 is a diagram illustrating a hardware configuration of the information processing device 100 according to the present disclosure. As illustrated in FIG. 15, the information processing device 100 includes a central processing unit (CPU) 110, a read only memory (ROM) 120, a random access memory (RAM) 130, a bus 140, a connection port 150, a storage device 160, and a communication device 170.

The CPU 110 functions as an arithmetic processing unit and a control device and implements the operation of the data processor 201 and the transmission controller 202 in the information processing device 100 in cooperation with a variety of computer programs. The CPU 110 may be a microprocessor. The ROM 120 stores computer programs, arithmetic operation parameters, or the like to be used by the CPU 110. The RAM 130 temporarily stores computer programs used in execution of the CPU 110 or parameters changing as appropriate in the execution. The ROM 120 and the RAM 130 implement a part of the storage unit 22 in the information processing device 100. The CPU 110, the ROM 120, and the RAM 130 are connected with each other through an internal bus including a CPU bus.

The storage device 160 is a device for data storage. The storage device 160 may include a recording medium, a recorder for recording data in a recording medium, a reader for reading data from a recording medium, and a deleting device for deleting data recorded on a recording medium. The storage device 160 stores a computer program executed by the CPU 110 and a variety of data.

The connection port 150 is, for example, a bus for connecting the information processing device 100 to an external information processing device or a peripheral device. The connection port 150 may be a universal serial bus (USB).

The communication device 170 is, for example, a communication interface configured with a communication device for connecting to a network, as an example of the communication unit 21 in the information processing device 100. The communication device 170 may be an infrared communication-supporting device, a wireless local area network (LAN)-supporting communication device, a long term evolution (LTE)-supporting communication device, or a wire communication device for wired communication.

### 4. CLOSING

As described above, in the information processing system according to embodiments of the present disclosure, information in a certain region is processed and abstracted data is transmitted to a higher-level device, whereby a hierarchical distributed database on distributed computers can be constructed.

Although preferred embodiments of the present disclosure have been described in detail above with reference to the accompanying drawings, the present technique is not limited to such embodiments. One having ordinary knowledge in the technical field of the present disclosure would arrive at a variety of changes and modifications without departing from the technical idea described in the claims, and it should be understood that these changes and modifications naturally fall within the technical scope of the present disclosure.

For example, a computer program may be created for allowing the hardware such as CPU, ROM, and RAM contained in the sensor terminal 1 or the server 2 described above to fulfill the functions of the sensor terminal 1 or the server 2. A computer-readable recording medium encoded with the computer program is also provided.

The effects described in the present description are only by way of explanation or illustration and is not intended to be limitative. The technique according to the present disclosure can achieve other effects apparent to those skilled in the art from the disclosure in the present description, in addition to the effects above or instead of the effects above.

The present technique may employ the configuration as follows.

(1)

An information processing device comprising a control unit configured to perform control to:

abstract information collected from a region in a certain range in accordance with setting information; and

transmit the abstracted information from a communication unit to a higher-level device.

(2)

The information processing device according to (1), wherein the control unit performs control to:

calculate a degree of importance of the abstracted information; and

transmit the abstracted information together with the degree of importance to the higher-level device.

(3)

The information processing device according to (1) or (2) above, wherein the setting information is setting of a degree of abstraction and a transmission frequency of abstracted information.

(4)

The information processing device according to any one of (1) to (3) above, wherein the setting information is transmitted from a higher-level device and defines a degree of abstraction required by the higher-level device.

(5)

The information processing device according to any one of (1) to (3) above, wherein the setting information is transmitted from a lower-level device and defines a degree of abstraction required by the lower-level device.

(6)

The information processing device according to any one of (1) to (3) above, wherein the setting information is input by an administrator and defines a degree of abstraction required by the information processing device.

(7)

The information processing device according to any one of (1) to (6) above, wherein

the region in a certain range corresponds to a local government level, and

a lower-level information processing device abstracts information collected from a region in a range corresponding to a local government below a local government level targeted by a higher-level information processing device.

(8)

The information processing device according to (7) above, wherein the information collected from a region in a certain range is information transmitted from one or more lower-level devices.

(9)

The information processing device according to (8) above, wherein the information transmitted from one or more lower-level devices is sensor data sensed in the region in a certain range.

(10)

The information processing device according to (8) or (9) above, wherein the information transmitted from one or more lower-level devices is information abstracted by the lower-level device.

(11)

An information processing method comprising performing control by a processor to:

abstract information collected from a region in a certain range in accordance with setting information; and

transmit the abstracted information from a communication unit to a higher-level device.

(12)

A computer program for causing a computer to function as a control unit performing control to:

abstract information collected from a region in a certain range in accordance with setting information; and

transmit the abstracted information from a communication unit to a higher-level device.

### REFERENCE SIGNS LIST

1 sensor terminal

10 control unit

11 communication unit

12 detection unit

13 storage unit

2 server

20 control unit

201 data processor

202 transmission controller

21 communication unit

22 storage unit

1. An information processing device comprising a control unit configured to perform control to:
abstract information collected from a region in a certain range in accordance with setting information; and
transmit the abstracted information from a communication unit to a higher-level device.

2. The information processing device according to claim 1, wherein
the control unit performs control to:
calculate a degree of importance of the abstracted information; and
transmit the abstracted information together with the degree of importance to the higher-level device.

3. The information processing device according claim 1, wherein the setting information is setting of a degree of abstraction and a transmission frequency of abstracted information.

4. The information processing device according to claim 1, wherein the setting information is transmitted from a higher-level device and defines a degree of abstraction required by the higher-level device.

5. The information processing device according to claim 1, wherein the setting information is transmitted from a lower-level device and defines a degree of abstraction required by the lower-level device.

6. The information processing device according to claim 1, wherein the setting information is input by an administrator and defines a degree of abstraction required by the information processing device.

7. The information processing device according to claim 1, wherein
the region in a certain area corresponds to a local government level, and
a lower-level information processing device abstracts information collected from a region in a range corresponding to a local government below a local government level targeted by a higher-level information processing device.

8. The information processing device according to claim 7, wherein the information collected from a region in a certain range is information transmitted from one or more lower-level devices.

9. The information processing device according to claim 8, wherein the information transmitted from one or more lower-level devices is sensor data sensed in the region in a certain range.

10. The information processing device according to claim 8, wherein the information transmitted from one or more lower-level devices is information abstracted by the lower-level device.

11. An information processing method comprising performing control by a processor to:
abstract information collected from a region in a certain range in accordance with setting information; and
transmit the abstracted information from a communication unit to a higher-level device.

12. A computer program for causing a computer to function as a control unit performing control to:
abstract information collected from a region in a certain range in accordance with setting information; and
transmit the abstracted information from a communication unit to a higher-level device.
